(19) United States
(12) Patent Application Publication
(10) Pub. No.: US 2023/0125055 A1
(43) Pub. Date: Apr. 20, 2023

(54) Systems and Methods for Dual-Mode Solar Heating and Radiative Cooling

(71) Applicant: Duke University, Durham, NC (US)

(72) Inventors: Po-Chun Hsu, Durham, NC (US); Yunfei Rao, Durham, NC (US); Chenxi Sui, Durham, NC (US)

(21) Appl. No.: 18/046,667

(22) Filed: Oct. 14, 2022

Related U.S. Application Data
(60) Provisional application No. 63/256,136, filed on Oct. 15, 2021.

(51) Int. Cl. G02F 1/1523; G02F 1/155; G02F 1/1333; G02F 1/1343

(52) U.S. Cl. CPC G02F 1/1525; G02F 1/155; G02F 1/133385; G02F 1/13439; G02F 2001/1555

(57) ABSTRACT

An electrochromic device includes an ultra-wideband transparent conducting electrode (UWB-TCE) including: a graphene layer; a gold microgrid on the graphene layer; and an IR-transparent substrate on the graphene layer and the gold microgrid. The electrochromic device is switchable between a solar heating mode and a radiative cooling mode including coating a metal layer on the UWB-TCE for the heating mode and stripping the metal layer for the cooling mode.

### RELATED APPLICATIONS

This application claims priority from U.S. Provisional Patent Application Ser. No. 63/256,136, filed Oct. 15, 2021, the disclosure of which is incorporated by reference in its entirety.

### BACKGROUND

As global warming and climate change worsen, developing effective heat management using renewable energy instead of the fossil fuels has become a pivotal subject. Residential usage accounts for more than 37% of electricity consumption in the United States. For building indoor temperature control, which alone accounts for more than 15% of national energy consumption, solar heating and radiative cooling are two of the most effective sustainable approaches. Solar heating is already a commercially successful technology, thanks to decades of efforts in both theory development and experimental demonstration. In recent years, sub-ambient daytime radiative cooling was demonstrated by photonic engineering the material that creates high solar reflectivity and high emissivity in the mid-infrared atmospheric window. These seminal works have led to a series of works with improved applicability, cost-effectiveness, and system-level innovation.

While both solar heating and radiative cooling can save energy, their single functionality can be a potential barrier for wide employment. Because of the seasonality of most regions of the U.S. and major cities in the world, the optimal modes of thermal management are different throughout the years, if not months or days. An ideal building envelope for the future net-zero-energy buildings should be capable of adapting its optical and thermal property in response to different parameters such as ambient conditions, occupants' demands, and electricity supply.

### SUMMARY

The Summary is provided to introduce a selection of concepts that are further described below in the Detailed Description. This Summary is not intended to identify key or essential features of the claimed subject matter, nor is it intended to be used as an aid in limiting the scope of the claimed subject matter.

One aspect of the present disclosure provides all that is described and illustrated herein.

Some embodiments of the present invention are directed to an electrochromic device including an ultra-wideband transparent conducting electrode (UWB-TCE). The UWB-TCE includes: an IR-transparent conductor layer; a metal microgrid on the IR-transparent conductor layer; and an IR-transparent substrate on the IR-transparent conductor layer and the metal microgrid. The electrochromic device is switchable between a solar heating mode and a radiative cooling mode including coating a metal layer on the UWB-TCE for the heating mode and stripping the metal layer for the cooling mode.

In some embodiments, the IR-transparent conductor layer includes a graphene layer. The graphene layer may be a graphene monolayer.

In some embodiments, the metal microgrid includes a gold microgrid.

In some embodiments, the IR-transparent substrate includes PE film.

In some embodiments, the UWB-TCE has a transmittance of at least 80% in the wavelength range of 0.2 μm to 20 μm.

In some embodiments, the UWB-TCE has a thickness of 3 nm or less.

In some embodiments, the UWB-TCE is flexible.

In some embodiments, the UWB-TCE has a sheet resistance of 25 ohm/sq or less.

In some embodiments, the UWB-TCE is a working electrode, and the device further includes a counter electrode and electrolyte between the working electrode and the counter electrode. The electrolyte may contain silver and/or copper ions.

Some other embodiments of the present invention are directed to a method of synergistic solar and radiative heat management. The method includes providing an electrochromic device including an ultra-wideband transparent conducting electrode (UWB-TCE), the UWB-TCE including: a graphene layer; a gold microgrid on the graphene layer; and an IR-transparent substrate on the graphene layer and the gold microgrid. The method includes switching the electrochromic device between a solar heating mode and a radiative cooling mode a plurality of times.

In some embodiments, switching the electrochromic device between the solar heating mode and the radiative cooling mode includes coating a metal layer on the UWB-TCE for the heating mode and stripping the metal layer for the cooling mode.

In some embodiments, the UWB-TCE is a working electrode, the electrochromic device further includes a counter electrode and electrolyte between the working electrode and the counter electrode. Coating the metal layer may include applying a first voltage to the UWB-TCE to deposit metal thereon. Stripping the metal layer may include applying a second voltage to the UWB-TCE to oxidize the metal to ions and dissolve the ions into the electrolyte.

In some embodiments, the graphene layer is a graphene monolayer.

In some embodiments, the IR-transparent substrate includes PE film.

In some embodiments, the UWB-TCE has a transmittance of at least 80% in the wavelength range of 0.2 μm to 20 μm.

Some other embodiments of the present invention are directed to an ultra-wideband transparent conducting electrode (UWB-TCE) for an electrochromic device. The UWB-TCE includes: a graphene layer; a gold microgrid on the graphene layer; and a PE film on the graphene layer and the gold microgrid.

The accompanying Figures and Examples are provided by way of illustration and not by way of limitation. The foregoing aspects and other features of the disclosure are explained in the following description, taken in connection with the accompanying example figures (also “FIG.”) relating to one or more embodiments.

### BRIEF DESCRIPTION OF THE DRAWINGS

FIG. 1A is a chart illustrating that ideal absorptivity/emissivity spectra of a synergistic solar and radiative dynamic heat managing device have exactly the opposite requirement for heating and cooling modes.

FIG. 1B is a schematic diagram illustrating that to switch between solar heating and radiative cooling, the TCE must be transparent to both solar and mid-IR radiation, meanwhile being highly conductive.

FIG. 1C is a schematic of the UWB-TCE according to some embodiments. The monolayer graphene provides uniform local conductance for charge transport, and the gold microgrid is responsible for long-range conductance with only minimal shadow loss of transmittance.

FIG. 2A is a chart illustrating transmittance spectra of UWB-TCE and other types of TCE from 0.2˜20 μm.

FIG. 2B is a chart illustrating TCE performance of sheet resistance versus transmittance in UV-Vis, NIR, and MIR wavelength regimes.

FIG. 2C is a chart illustrating Raman spectra of different layers graphene on the electrode.

FIG. 2D is a chart illustrating UV-Vis, NIR, MIR transmittance of different layers graphene on the electrode.

FIG. 2E is a chart illustrating results from a cyclic bending test with bending radius of 1 cm.

FIG. 3A is a schematic diagram of an IR electrochromic device according to some embodiments. Because of the broadband transmittance of UWB-TCE, the emissivity is determined by the underlying electrolyte/metal at the cooling/heating mode.

FIG. 3B includes thermal images of the device of FIG. 3A at cooling and heating modes.

FIG. 3C is a chart illustrating emissivity spectra of the device of FIG. 3A at cooling and heating modes.

FIG. 3D is a chart illustrating weighted-average emissivity at cooling and heating states versus cycles. The deposition charge density was 125 mC/cm² in heating state in for the charts of FIGS. 3B-3D.

FIG. 3E is a chart illustrating the controlling the devices at different emissivities (λ=10 μm). The deposition charge density for emissivity of 0.1, 0.4 and 0.7 were 125, 60, and 35 mC/cm², respectively. The calculated radiative heat transfer coefficients are shown as the secondary y-axis.

FIG. 3F is a chart illustrating total heat transfer coefficients measured by the guard heater method in an environmental chamber.

FIG. 4A is a schematic diagram illustrating the Schematic of the electrochromic device working principle. The emissivity is determined by the layer beneath the UWB-TCE, and the solar reflectivity is determined by the Ag back reflector at the stripped state and by the Ag nanoparticles at the coated state.

FIG. 4B includes visible (bottom row) and infrared (top row) images of the device at cooling and heating states. The cooling mode behaves as a high-emissivity solar reflector, and the heating mode behaves as a low-emissivity solar absorber.

FIG. 4C includes SEM images of the UWB-TCE film at different charge densities.

FIG. 4D is a chart illustrating solar and mid-IR absorptivity/emissivity spectra of the UWB-TCE film at different charge densities.

FIG. 4E is a chart illustrating weighted-average absorptivity/emissivity of the deposited metals on UWB-TCE film at different charge densities.

FIG. 4F is a chart illustrating spectra of solar absorption and infrared emittance of device at the cooling and heating states.

FIG. 4G is a chart illustrating solar absorptivity (λ=550 nm) and infrared emissivity (λ=10 μm) at cooling and heating states by controlling device with several cycles with 0.5 nm thickness of Pt.

FIG. 4H is a chart illustrating solar absorptivity (λ=550 nm) and infrared emissivity (λ=10 μm) at cooling and heating states by controlling device with several cycles with 0.75 nm thickness of Pt (h). The electrodeposited charge density is 75 mC/cm2 in the heating state for FIGS. 4B, 4F, 4G, and 4H.

FIG. 5 is a scanning electron microscope (SEM) image of AgNW with PE substrate.

FIG. 6 is a chart illustrating cyclic voltammograms of the electrochromic device. UWB-TCE is used as the working electrode, ITO glass is the counter electrode, and the gel electrolyte includes 50 mM AgNO₃, 250 mM TBABr, 10 mM CuCl₂ in dimethyl sulfoxide (DMSO) solution.

FIG. 7 includes charts illustrating Raman spectra of different layers graphene on the electrode.

FIG. 8 includes schematic diagrams illustrating the fabrication process of the UWB-TCE according to some embodiments. (a) Monolayer graphene on copper. (b) The photolithography process after spin coating with negative photoresist. (c) Development process after exposures and baking. (d) Gold evaporation (200 nm thickness). (e) Lift-off and rinse the remaining photoresist with acetone. (f) The PE substrate was attached to the graphene/Au grid by hot pressing. Temperature and duration were 96° C. and 60 s, respectively. (g) Etching copper by iron chloride (III) solution to get the UWB-TCE.

FIG. 9 is a schematic diagram of a thermal measurement apparatus. Note that the dimensions are not to scale.

FIG. 10 illustrates the operation of the electrochromic device according to some embodiments.

### DETAILED DESCRIPTION

For the purposes of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e. at least one) of the grammatical object of the article. By way of example, “an element” means at least one element and can include more than one element.

“About” is used to provide flexibility to a numerical range endpoint by providing that a given value may be “slightly above” or “slightly below” the endpoint without affecting the desired result.

The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”).

As used herein, the transitional phrase “consisting essentially of” (and grammatical variants) is to be interpreted as encompassing the recited materials or steps “and those that do not materially affect the basic and novel characteristic(s)” of the claimed invention. Thus, the term “consisting essentially of” as used herein should not be interpreted as equivalent to “comprising.”

Moreover, the present disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

Like numbers refer to like elements throughout.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

One aspect of the present disclosure provides an electrochemical device that can switch between solar heating and radiative cooling mode to utilize renewable heating and cooling sources for building envelopes, wearable applications, and other heat management. The device is thin, lightweight, safe, and does not have any moving parts.

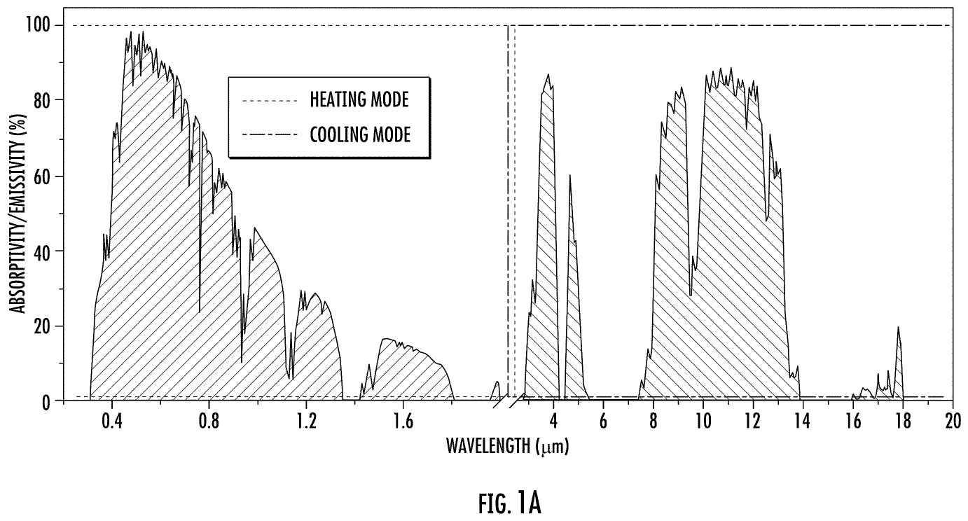

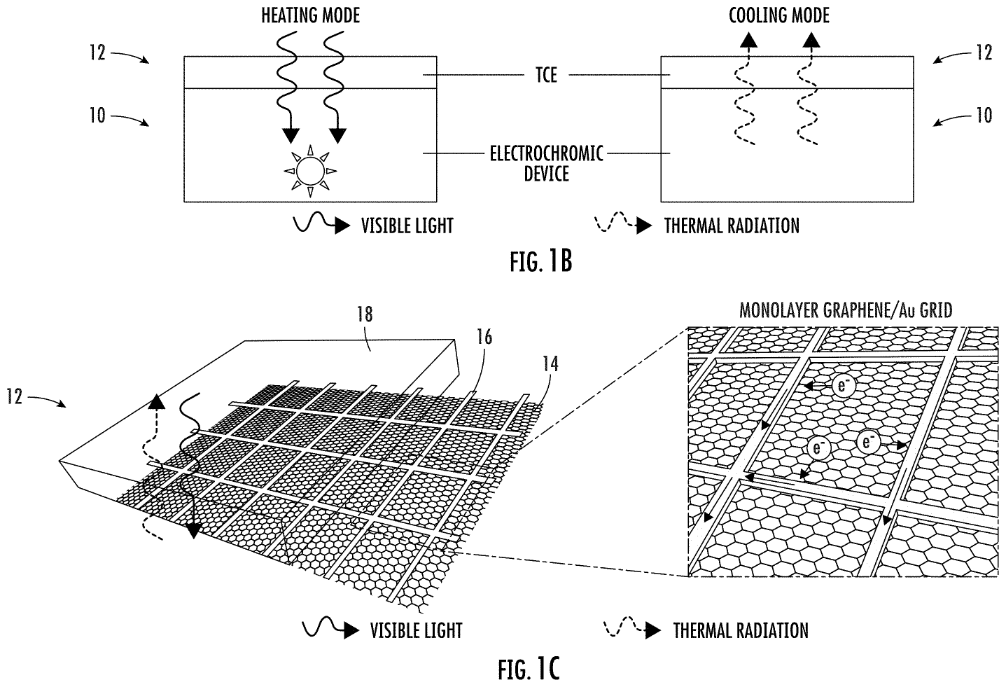

FIG. 1 illustrates an ultra-wideband transparent conducting electrode (UWB-TCE) for electrochromic synergistic solar and radiative heat management.

To create a smart building envelope that can switch between solar heating and radiative cooling, the device must be tunable in a substantially wide bandwidth: from ultraviolet (˜300 nm in wavelength) to mid-infrared (mid-IR, ˜25 μm for ambient thermal radiation or ˜14 μm for atmospheric window). Ideally, low solar absorptivity and high thermal emissivity works in radiative cooling state, and high solar absorptivity and low thermal emissivity works resulting in solar heating (FIG. 1A). Note that absorptivity equals emissivity according to Kirchhoff's radiation law. Electrochromic devices (ECDs) are a promising technology of smart building envelope for net-zero energy buildings. Substantial progress has been made in various aspects, ranging from fundamental materials and photonic science to system level field testing and commercialization. In particular, metal- and oxide-based ECDs both show exciting performance and functionality as smart windows in the past decades, and polymer-based ECDs are appealing for the variety of color choices and flexibility. Other types of smart windows with triggers from temperature, photon, or mechanical strain also have unique advantages and suitable applications scenarios. Nevertheless, the tunable wavelength range was mainly for solar spectrum and the advantage of mid-IR tuning has been overlooked. On the other hand, ECDs specifically designed for mid-IR have been reported, but the solar heat gain modulation was not considered. Indeed, the challenge to accomplish wideband and opposite emissivity modulation (FIG. 1A) is nontrivial. Most pioneering works, although original and inspiring, showed suboptimal optical property combination, i.e., low thermal emissivity at radiative cooling state or high thermal emissivity at solar heating state. A roll-to-roll device was recently reported to be able to effectively switch between solar heating and sub-ambient daytime radiative cooling by mechanically moving the heating/cooling film and creating reversible thermal contact. Nonetheless, the working principle involves moving part and may need further research for wide employment in buildings.

One major missing piece to realize an electrochromic device 10 that manage both sunlight and thermal radiation is the transparent conducting electrode (TCE). In the last ten years, great progress has been made in both fundamental research and fabrication technology. As shown in FIG. 1B, only when the TCE is transparent to both solar and mid-IR radiation can the underlying electrochromic components be effective, otherwise the performance will always be limited by the TCE. Take indium tin oxide (ITO) for example, ITO has decent transmittance in visible and near-IR region that can allow the control of sunlight. However, ITO is opaque and highly reflective in mid-IR and therefore has a low emissivity/absorptivity (Kirchhoff's law). As a result, the overall thermal emissivity will always be low, limiting the cooling performance. Similar argument applies for materials that are opaque and highly absorptive, too. Here, we designed and demonstrated an ultra-wideband transparent conducting electrode (UWB-TCE) 12 with low sheet resistance and high optical transmittance in the wavelength of 0.2˜20 μm to allow the underlying active material to fully perform its solar/radiative heat management by varying the electrochemical potential. The UWB-TCE 12 is composed of monolayer graphene 14, gold microgrid 16, and polyethylene (PE) membrane 18 (FIG. 1C). Monolayer graphene and gold microgrid can provide local and long-range conductance, respectively, which guarantees uniform property change and low ohmic loss. PE film is an IR-transparent flexible substrate. With the UWB-TCE as the working electrode, we demonstrate the plasmonic ECD using Ag—Cu solution as the electrochromic material system. For mid-IR radiative tuning only, the ECD can vary its emissivity (weighted average by 300 K black body radiation) between 0.12 and 0.94. This large emissivity contrast of 0.82 is among the highest reported values so far. The ultra-wideband transmittance further allows us to vary between solar heating and radiative cooling via controlling plasmonic absorption. The solar absorptivity (α) and thermal emissivity (ε) of solar heating and radiative cooling mode are (α, ε)=(0.60, 0.20), and (0.33, 0.94), respectively. With the high transmittance in both solar and thermal radiation regimes, our UWB-TCE can be a new key component for electrically tunable device in multispectral thermal energy management and display and find useful applications in sustainability, energy, consumer electronics, military and civil applications, and personal health.

Graphene has been regarded as a promising TCE material because of its high carrier mobility and angstrom-level thickness. The unique Dirac cone band structure of monolayer graphene result in a constant and wavelength-independent transmittance of

$$T \approx 1 - πα = 1 - \frac{π {e}^{2}}{ℏ c} = 1 - 2.3 \% = 97.7 \% .$$

This broadband multispectral feature makes monolayer graphene the most ideal material for UWB-TCE. The gold microgrid is 10 μm in width and 1 mm in spacing, so the shadow loss is only 2%. According to the wire mesh screen model, this small shadow loss can also be regarded as wavelength-independent up to the cutoff wavelength that is on the order of 1 mm in free space or 0.3 THz in the radio frequency domain. Meanwhile, the gold microgrid can significantly reduce the long-range sheet resistance, which is essential for fast and efficient electrochromic switching. The choice of microgrid geometry is apparently the outcome of optimization among electrochemical reaction kinetics, electromagnetic wave transmittance, and materials' intrinsic properties, and we anticipate our proof-of-concept demonstration in solar and mid-IR synergistic heat management contains broader impact to other electromagnetic wavelengths and applications. Finally, PE film is chosen as the substrate for its broadband transmittance from visible light to mid-IR. Its mechanical flexibility and low cost are also important features for large-scale adoption, similar to roll-to-roll low-emissivity window films for retrofitting applications.

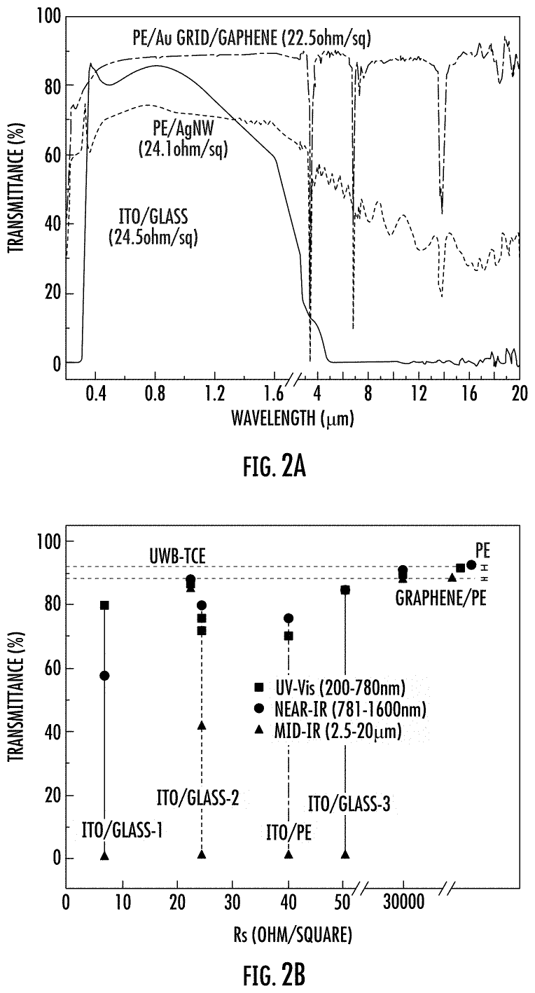

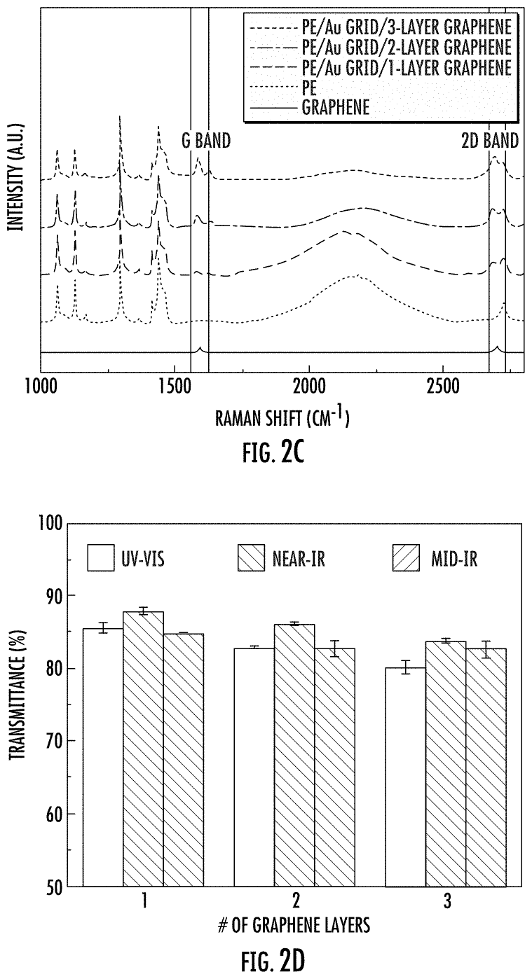

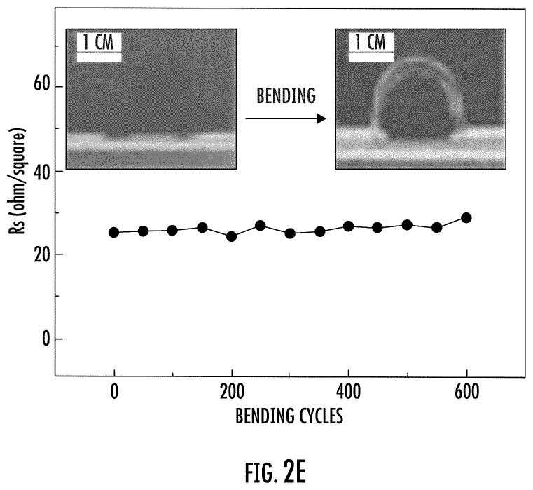

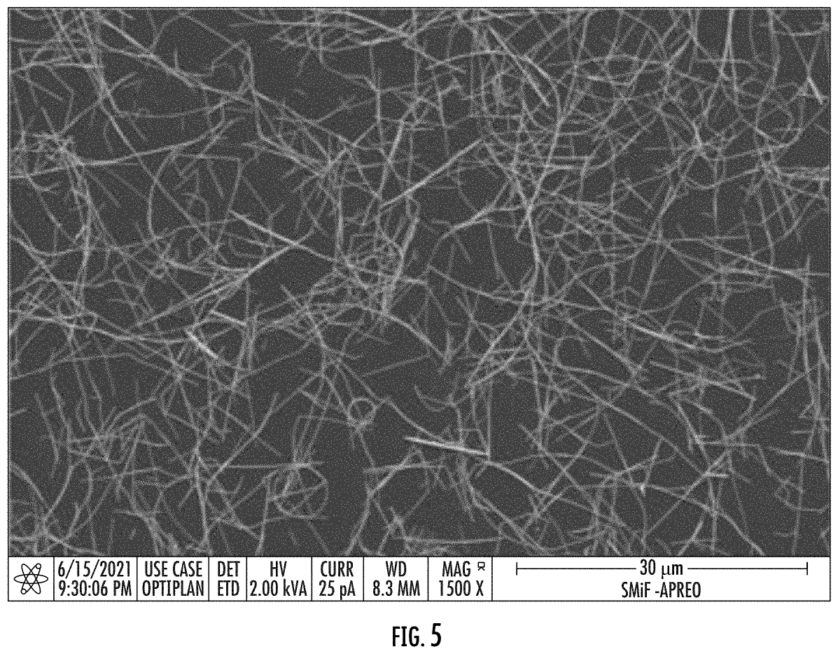

The broadband transmittance of our UWB-TCE can be clearly shown by comparing with other common TCEs with approximately the same sheet resistance of 22˜25 ohm/sq. As shown in FIG. 2A, ITO/glass, the most common TCE, exhibits the cutoff below 350 nm of ultraviolet (UV) due to interband absorption. The transmittance is higher in the visible light range but then begins to decline at near-IR due to reflection loss by free carriers. The transmittance is nearly zero at mid-IR. AgNW/PE has a flatter spectrum, but the overall value is much lower in the visible regime at around 70%, which also decrease as the wavelength increases. Based on the scanning electron microscope (SEM) image (FIG. 5), the decrease is likely caused by the reflection of AgNW mesh with smaller hole sizes. Our UWB-TCE shows the flattest spectrum with slow decay in the deep UV and narrow absorption peaks in mid-IR, both caused by the PE substrate. It is worth noting that, these decrease of transmittance, while insignificant, can be further mitigated by removing the impurities and increasing the molecular weight and chain orientation, thereby further boosting the performance of UWB-TCE.

In FIG. 2B, we further measured the sheet resistance (Rₛ) and made the Rₛ-T plot for various TCEs. The transmittance are represented based on three bands: UV-visible (0.2˜0.78 μm), near-IR (0.78˜1.6 μm) and mid-IR (2.5˜20 μm), which are weighted-averaged based on AM1.5 hemispherical solar radiation (ASTM G-173) or 300K black body radiation via the Planck's law. All three datapoints of UWB-TCE are in the upper left area, representing the best overall performance: Rₛ=22.4 ohm/sq, T_{UV-Vis}=85.63%, T_{near-IR}=87.85%, and T_{mid-IR}=84.87%. If the PE substrate effect is eliminated, the transmittance will become 94.24%, 95.56% and 96.62%, respectively.

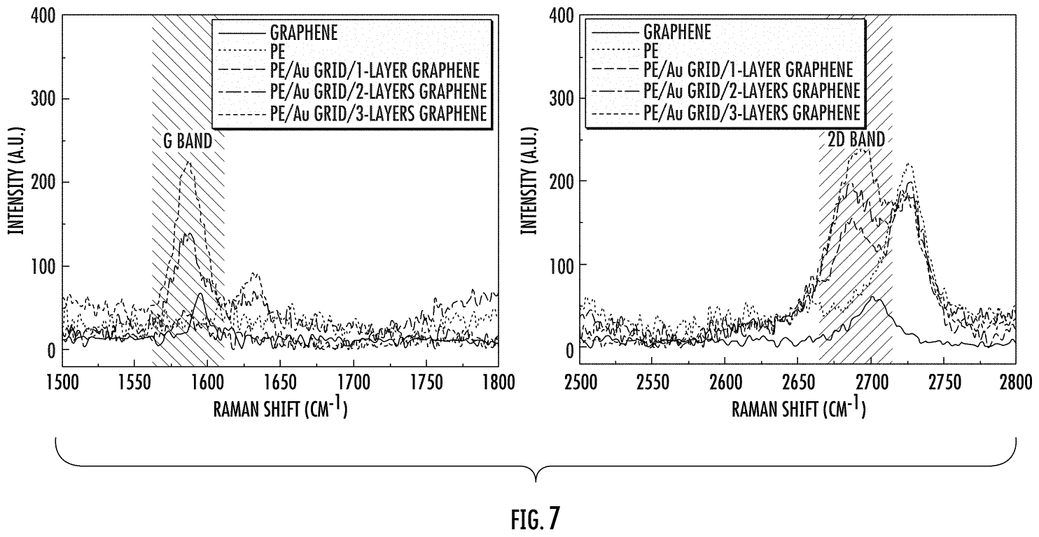

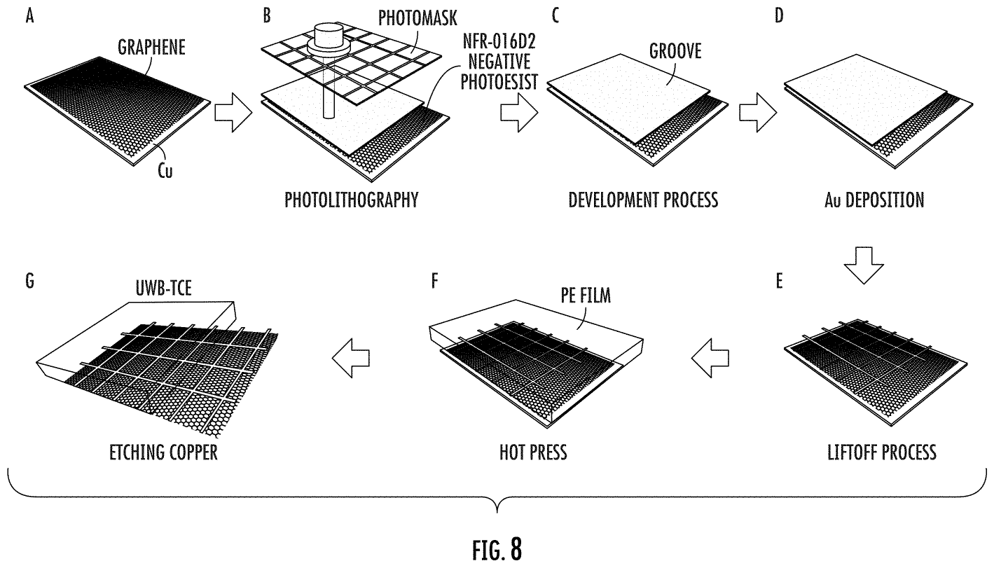

We further investigated the effect of number of graphene layers on the electrical sheet resistance and optical properties of UWB-TCE. FIG. 2c shows the Raman spectra of UWB-TCE of different layer numbers as well as pure graphene and PE substrate as references. The increased intensity ratio of G to 2D band (IG/I2D) and the up-shift of 2D band position, as shown in FIG. 7 and Table 1, which confirm the increase in the number of graphene layer. As the number of layers increases, transmittance decrease stepwise as expected (FIG. 2D). Although higher number of layers decreases the local resistance, the benefit is outweighed by the optical loss because the gold microgrid is already responsible for most of the electron transport at the device level. In practice, for radiative cooling, suppressing solar absorptivity is essential because of the high intensity of solar radiation, so it is more desirable to choose transmittance over sheet resistance. Moreover, if ohmic loss became critical, reducing the spacing of gold grid is still the preferred solution because it will increase the device reflectance rather than absorption. Finally, the material choice combination renders UWB-TCE mechanical flexibility. The sheet resistance remained stable during 600 bending cycles at the radius of 1 cm (FIG. 2E).

TABLE 1
Values of G band and 2D band of different
layers graphene on the electrode.

| Materials | G band | 2D band | G/2D |
|---|---|---|---|
| PE/Au grid/1 layer | 47.28 | 156.70 | 0.30 |
| graphene | | | |
| PE/Au grid/2 layers | 139.54 | 198.15 | 0.70 |
| graphene | | | |
| PE/Au grid/3 layers | 225.26 | 247.86 | 0.91 |
| graphene | | | |

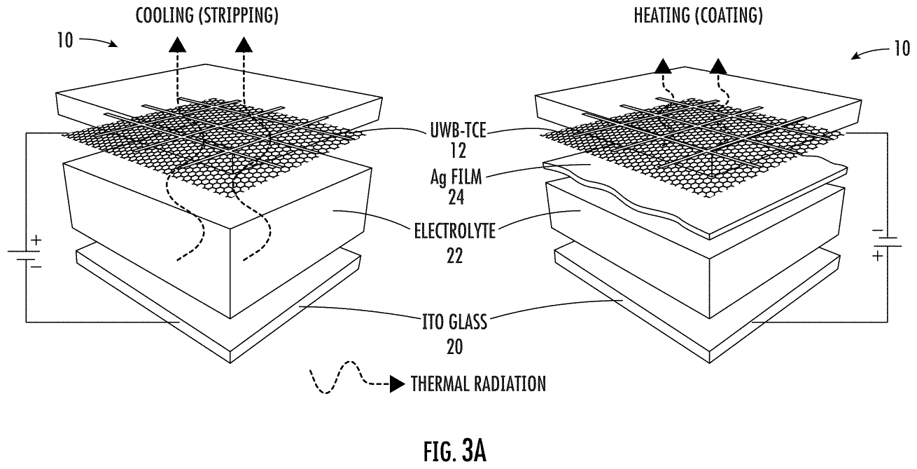

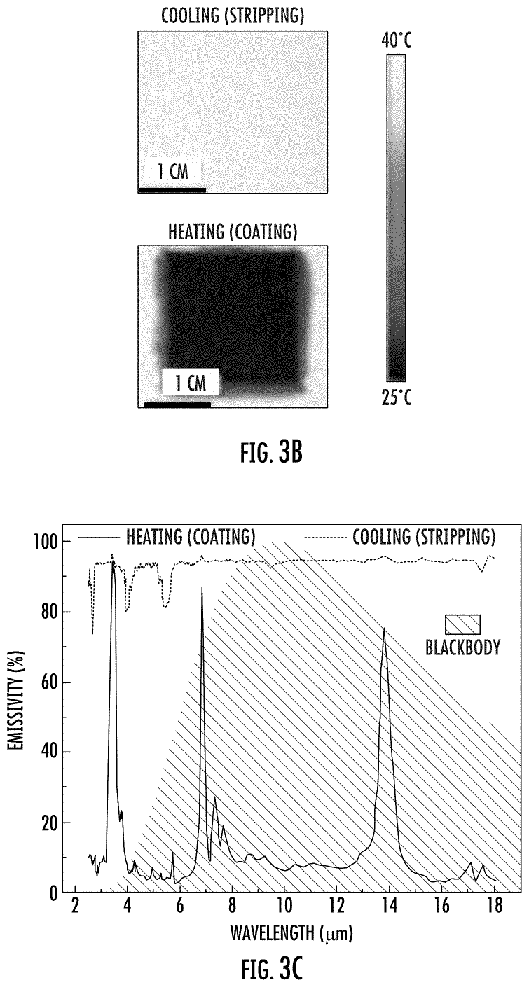

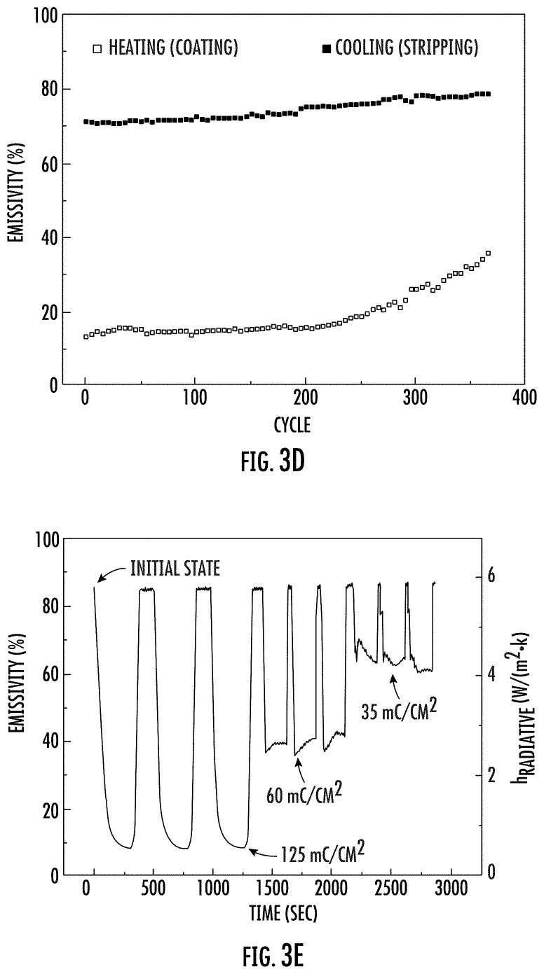

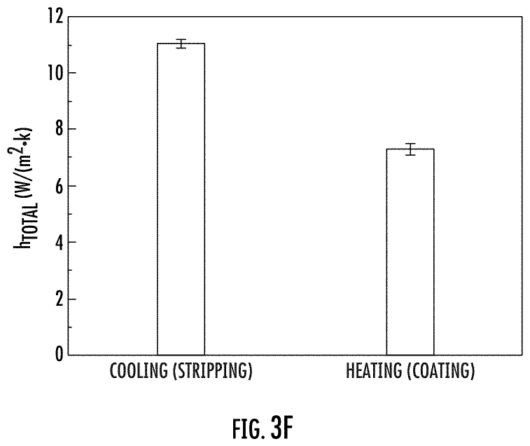

As demonstrated in the previous comparison with ITO and AgNW (FIG. 2A), the mid-IR transmittance of UWB-TCE is indeed a remarkable feature. Therefore, we first demonstrate its utility to regulate infrared radiation by the metal-based electrochromism using UWB-TCE 12 as the working electrode, ITO glass as the counter electrode 20, and gel electrolyte 22 containing silver and copper ions (FIG. 3A). Small quantity of copper ion was added to be co-deposited with silver, which facilitate reversible deposition through Cu⁺ mediation. The electrochemical reaction loop is closed by the Br₃⁻/Br⁻ redox couple supplied by tetrabutylammonium bromide (TBABr). We note that a recent study has used Ag-based electrochromism for thermal camouflage using percolating semi-continuous Pt film as the electrode.

The initial state of the device (stripped state) was shown in FIG. 3A. Because UWB-TCE is transparent in mid-IR, the emissivity is determined by the underlying electrolyte. Most polar solvents, including DMSO and water, are strongly IR-active and absorbing. As the Kirchhoff s radiation law states that spectral absorptivity and spectral emissivity are equal at thermal equilibrium, the stripped state has high emissivity due to the electrolyte and thus work in the radiative cooling mode. Note the choice of the ITO/glass does not influence the emissivity tuning because all the mid-IR emissivity is determined by the IR-absorbing (and thus IR-emitting) electrolyte.

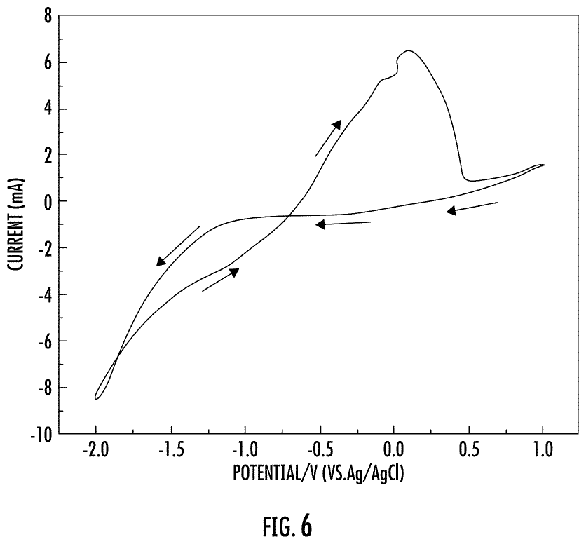

The device can be switched from cooling (high-ε) to heating (low-ε) by electrodepositing metal onto the UBW-TCE. Three-electrode cyclic voltammetry was implemented to investigate the electrochemical potentials of metal deposition and dissolution. As illustrated in (FIG. 6). When the potential exceeds 1.5 V during the negative potential sweep, cathodic current begins to increase sharply, which was attributed to the deposition of Cu and Ag. As a result, silver and copper metals were co-deposited gradually to form a thin layer metals. The low-emissivity metal layer 24 (FIG. 3A) therefore dominates the device radiative property and decrease the thermal radiation significantly, as captured by the thermal camera (FIG. 3B). This mode is the heating state due to the suppression of radiative heat loss. When a positive voltage (+0.1V) is applied to the UWB-TCE, the Ag—Cu metals are oxidized to ions and dissolved into the electrolyte, and the device goes back to the initial cooling state. Fourier-transform infrared spectroscopy (FTIR) was used to characterize the emissivity (absorptivity) spectra of the device at two modes. Because the device is IR-opaque, we measured the reflectivity (ρ) and calculate the absorptivity (α) by α=1−ρ, and the Kirchhoff's law is used again to obtain the emissivity, i.e. ε=α. Both heating and cooling modes show broadband emissivity spectra, which is advantageous for thermoregulation. The heating mode spectrum exhibits the same characteristic absorption peaks of PE.

FIG. 3D shows the IR-electrochromic device can maintain large emissivity contrast for up to 200 cycles and remained 80% after 350 cycles. We note the low-emissivity state degrades more than the high-emissivity state, which may be due to irreversible formation of metal chlorides or oxides. Furthermore, the electrochromic device can operate in various emissivities, which is a great advantage to provide continuous and high-precision radiative thermoregulation. As shown in FIG. 3E, the device's emissivity can be maintained at 0.1, 0.4 and 0.7 by controlling the electrodeposited charge density to 125, 60, and 35 mC/cm², respectively. The radiative heat transfer coefficients can be calculated by h_{radiative}=4σεT³, where α is Stefan-Boltzmann constant, ε is the thermal emissivity of device and T is the average of the device surface temperature and the ambient temperature.

To experimentally demonstrate the radiative thermal property, we used the guard heater method in a temperature-controlled chamber to measure the total heat transfer coefficients that includes both radiation and natural convection. The total heat transfer coefficients of cooling and heating modes were 11.02 W/(m²·K) and 7.31 W/(m²·K) respectively. If we assume the temperature difference between the object and the ambience is 10° C., then the ECD can effectively modulate the heat flux by 37.1 W/m². As a rule-of-thumb comparison, this amount of thermoregulation is more than one third of the human body metabolic heat rate (˜100 W/m²) or a typical cooling load for a modern house (One ton of air conditioning per 400 sqft), which indicate its substantial impact on these applications. The advantage can be further emphasized by noting the modulated heat flux is through controlling the “valve” of heat loss rather than directly pumping the thermal power in/out of the object, so the operational power consumption is only for switching states or compensating for non-Faradaic capacity loss, rather than for constantly supplying heat/work.

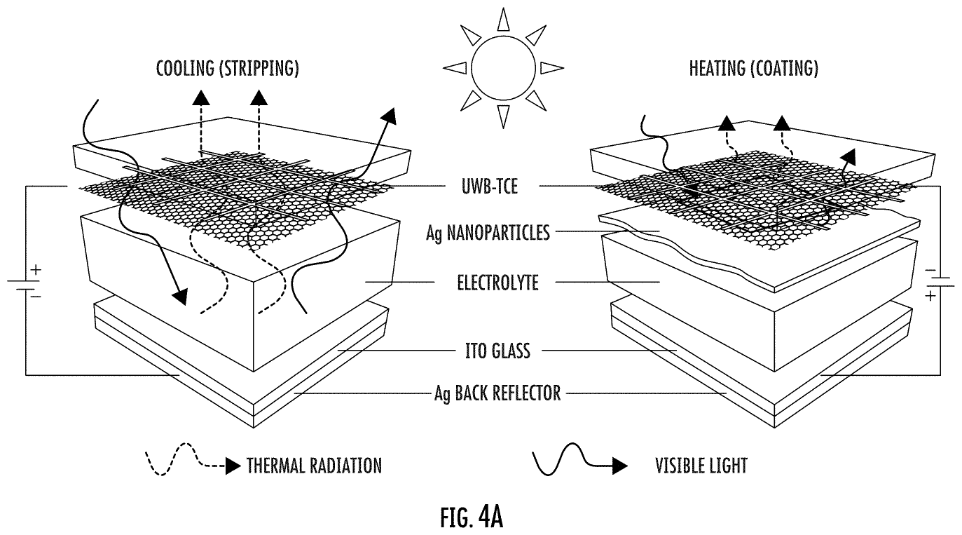

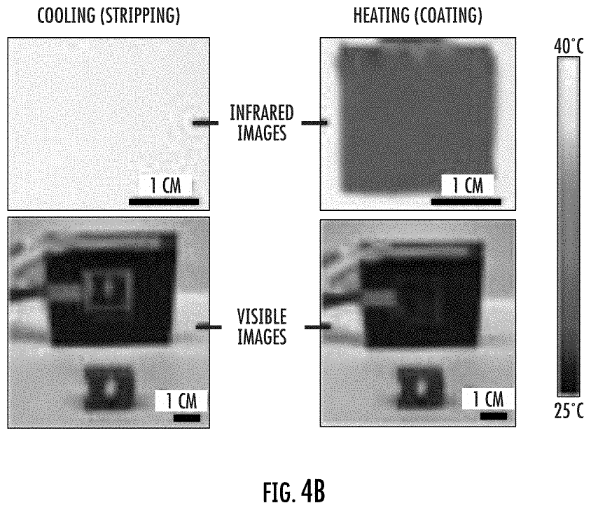

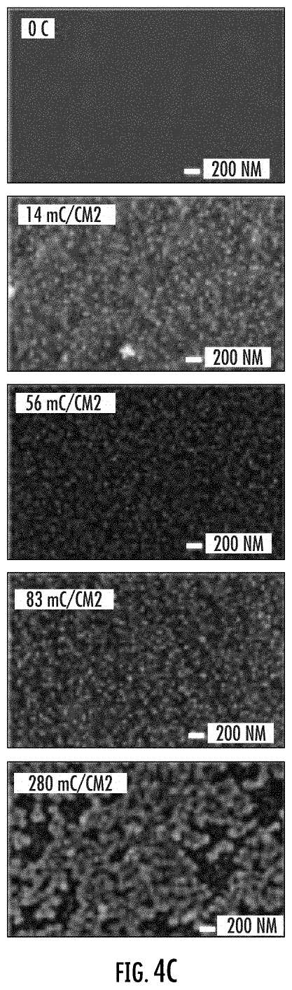

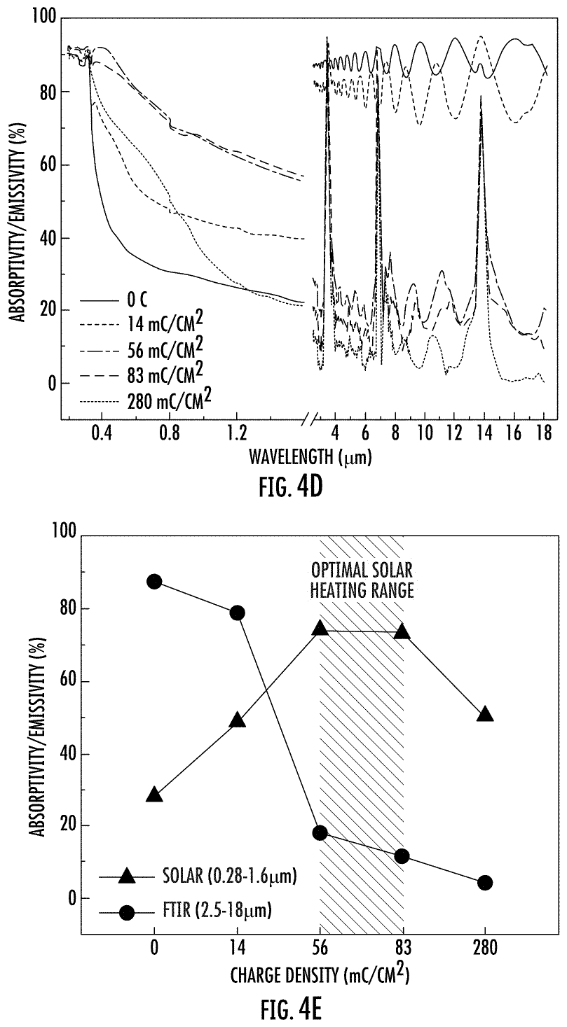

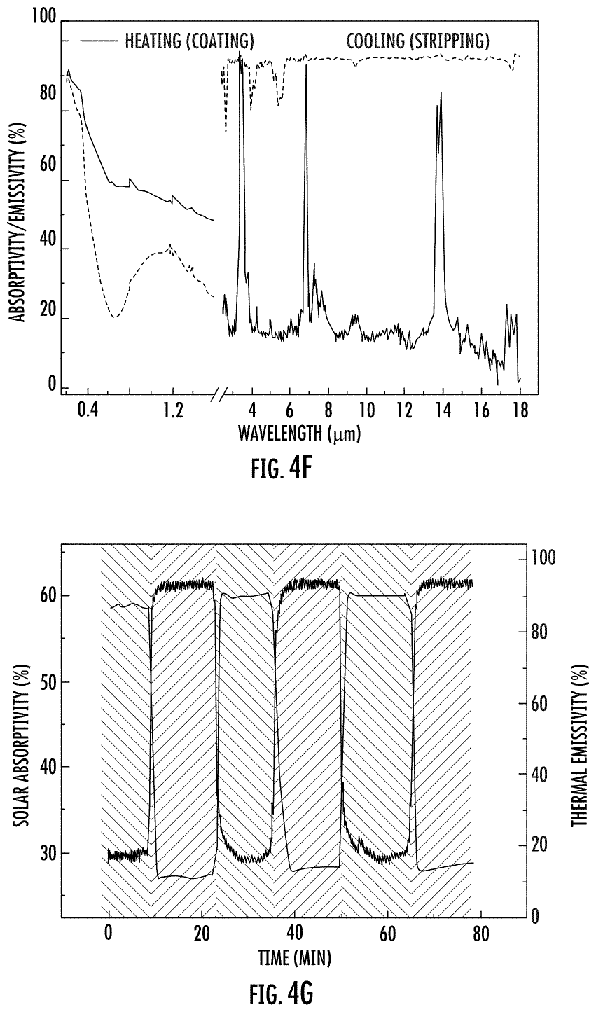

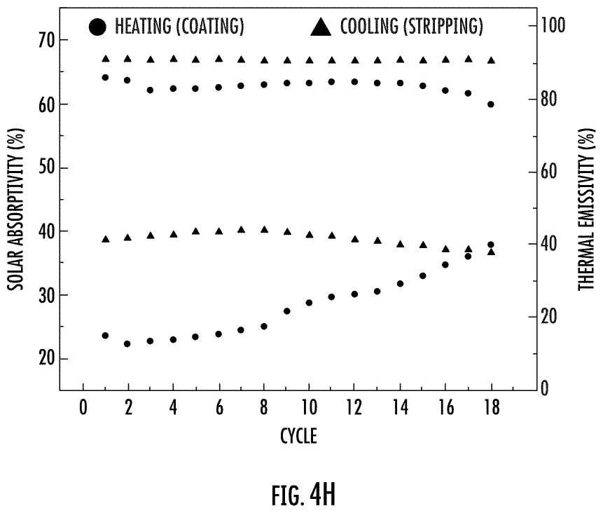

FIG. 4 provides experimental demonstration of synergistic solar and mid-IR radiative heat management.

The metal-based electrochromism not only has exceptional emissivity modulation capability but can also perform solar/mid-IR dual-band synergistic thermoregulation after implementing two modifications: metal morphology optimization and solar reflector (FIG. 4A). When the electrodeposited metal is discontinuous with proper particle sizes and distribution, it becomes a plasmonic selective absorber. Specifically, random metal nanoparticles and nanoclusters result in broadband localized surface plasmon resonance that is strongly absorbing in solar spectrum. For mid-IR that has much longer wavelengths, the optical properties are dictated by the effective medium theory, which means the emissivity (absorptivity) is lower by the metallic component. For radiative cooling, a silver mirror is deposited onto the backside of the ITO glass counter electrode and serves as the solar reflector. The mid-IR emissivity is still determined by the electrolyte. The overall effect is a high-emissivity solar reflector, the same as the passive daytime radiative coolers. Essentially, the solar/mid-IR ECD operates between the stripped state and the metal nanoparticle state, and the back reflector rejects the solar heat gain to promote daytime cooling.

As shown in FIG. 4B, when the working electrode is stripped (transparent), the underlying silver mirror can reflect visible light and show the blue letter “D”, meanwhile, thermal imaging shows the high emissivity. Note the higher nominal IR temperature indicates higher radiosity/emissivity rather than true temperature. As negative bias is applied to the UWB-TCE, electrodeposition begins, and Ag nanoparticles start to nucleate. Before the Ag grow into a thin film as in FIG. 4A, there exists an optimal state where the deposit is very close to the percolation threshold, which exhibits both plasmonic absorption of visible light and classical Drude metal reflection of mid-IR radiation. As a result, the device appears black and cannot show the blue letter “D” anymore, and its thermal image also shows low emissivity (high reflectivity). These visible and IR photos in FIG. 4B clearly demonstrate the synergistic solar and mid-IR radiative heat management.

We further study the near-percolation phenomenon by correlating the surface morphology (FIG. 4C) with optical measurement results (FIGS. 4D and 4E). Indeed, as the deposited Ag increases from 0 to 280 mC/cm², the nanoparticles gradually grow and merge into percolating porous film. Based on effective medium approximations (EMA) theory, for long-wavelength light such as mid-IR, the electrodeposited silver can be seen as a whole, so the emissivity decreases monotonically as the more Ag is deposited (FIG. 4E, red). On the other hand, the solar absorptivity shows a non-monotonic “volcano” shape, which increases initially from 0.34 (0 mC/cm²) to 0.76 (56 mC/cm²) and 0.75 (83 mC/cm²), and finally decreases to 0.55 (280 mC/cm²). The outcome is that the device has both high solar absorption and low mid-IR emissivity between 56 and 83 mC/cm², which corresponds to the heating mode. Finally, to demonstrate the electrochromic dual-band synergistic heat management, we switched the device between 0 and 75 mC/cm² and measured the solar absorption and infrared emissivity spectra and time series (FIGS. 4F and 4G). The device exhibits a decent switching speed and contrast of 0.74 in mid-IR and 0.27 in solar bands. Although the solar reflectivity at the cooling mode is not high enough to accomplish sub-ambient cooling, the current performance of the solar-mid-IR dual-band synergistic heat modulation provides a promising design platform for further development in both interfacial electrochemistry and device thermal engineering.

In summary, we successfully demonstrated a graphene-based UWB-TCE with ultra-wideband (0.2˜20 μm) high transparency and low sheet resistance, which is the key missing component to accomplish electrochromic devices for both IR tuning and synergistic solar and mid-IR dual-band heat management.

The electrochromic device is based on reversible metal deposition, which exhibited high contrast in mid-IR range (2.5˜18 μm) and good cycling performance (>360 cycles) for thermal radiation tuning. The large tunable apparent temperature range of ˜15° C. under 40° C. environment makes it attractive in thermal regulation and energy saving. The synergistic solar/mid-IR dual-band tuning is accomplished by optimizing between near-percolation plasmonic solar absorption and effective medium approximation mid-IR reflection, which dynamically switches between solar heating and radiative cooling with contrast in solar and mid-IR wavelengths of 0.27 and 0.74, respectively. As the first demonstration of UWB-TCE and electrochromic synergistic solar/mid-IR device, the current solar absorptivity is not yet low enough to produce sub-ambient cooling. Further improvement of electrolytes and other components' properties or incorporating optical scatterers would be needed to boost the cooling performance. On the other hand, for solar heating, how to delay the percolation threshold so that the metal film can be darker at high mass loading would be a possible direction. Besides solar and mid-IR broadband tuning, individual control of visible color and/or near-IR property via plasmonic resonance will also be of great practical interests.

It should be noted that our UWB-TCE can also apply to other types of electrochromic devices after proper device engineering and surface treatment, which can bring a plethora of future opportunities. The electrochromic device must also have a wholistic consideration for other performance metrics such as switching efficiency, speed, durability, and real heat transport optimization. We anticipate that, further development of the graphene UWB-TCE, reversible metal electrodeposition, and photonic structure design, can lead to more powerful multispectral and multimodal heat management that can find immense applications for sustainable energy, wearable devices, green buildings, and consumer electronics.

### Example

Experimental Methods

UWB-TCE synthesis. The fabrication process of UWB-TCE is elaborated in FIG. 8. Chemical vapor deposition (CVD)-grown monolayer graphene on copper foil (FIG. 8A) was used for its uniform, large, and continuous domains. The gold microgrid is directly fabricated onto the graphene/Cu by photolithography using negative photoresist (NFR-016D2), electron-beam evaporation (Kurt J. Lesker PVD 75), and lift-off process in FIGS. 8B-E. The width, spacing, and thickness of the microgrid were 10 μm, 1 mm, and 200 nm, respectively. PE film was attached to the gold grid/graphene by hot pressing, as shown in FIG. 8F. The temperature and pressure should be carefully controlled to ensure enough mobility of the macromolecules for large-area bonding without completely turning the polymer into a liquid. On the other hand, low temperature results in weak bonding between PE and graphene. Lastly, the UWB-TCE was finished after etching the copper foil with iron (III) chloride solution.

Device preparation. UWB-TCE with sputtered Pt (nominal thickness less than 3 nm) as the working electrode and ITO glass (˜10 ohm/square) as the counter electrode. The Pt nanoparticles were for catalyzing the dynamic metal deposition. The gel electrolyte was prepared by mixing 50 mM AgNO₃ (Sigma-Aldrich), 10 mM CuCl₂ (Sigma-Aldrich), 250 mM tetra-butyl-ammonium bromide (TBABr; Sigma-Aldrich), and 10 weight % polyvinyl butyral [PVB; Sigma-Aldrich] in dimethyl sulfoxide (DMSO; Sigma-Aldrich) solution. The double-sided acrylic tapes (3M, ˜0.25 mm) were used for sealing and preventing the working electrode from directly contacting with the counter electrode.

Sample Characterization

Sheet resistance. The sheet resistance of different membranes was measured by a four-probe resistivity measurement system RC2175 (EDTM).

Electrochemistry Characterization. The cyclic voltammetry curve of the device was done by VMP3 (BioLogic Inc.), and the scan speed was set at 20 mV/s.

UV-vis and FTIR Characterization. The ultraviolet-visible (UV-Vis) transmittance, reflectance spectra, and real-time test of the samples with a wavelength range of 0.2 to 1.6 μm were measured using Cary 6000i (Agilent technologies) equipped with a PTFE diffuse integrating sphere. The infrared spectra and real-time test of the samples with a wavelength range of 2.5 to 20 μm were measured by iS50 (Thermo Scientific) equipped with a diffuse gold integrating sphere.

IR camera. The infrared images and videos were recorded using IR cameras (FLIR E60).

SEM characterization. The highly magnified surface morphology of the nanoscopic electrodeposited metals was characterized using a high-resolution field-emission scanning electron microscope (Apreo S by ThermoFisher Scientific). Samples were cleaned in ethanol solutions and subsequently dried under a stream of N₂ before putting into the SEM chamber.

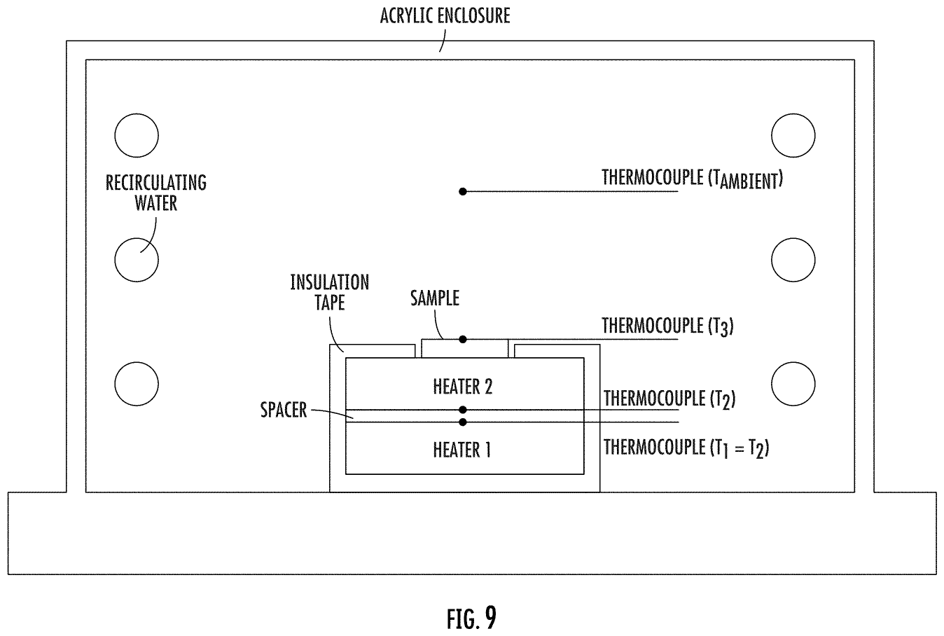

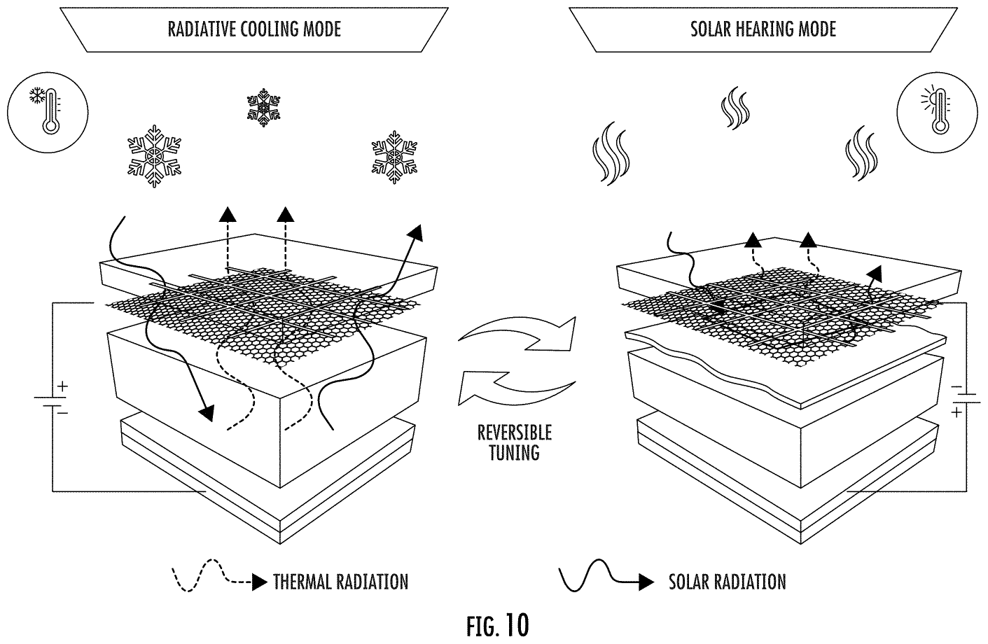

Heat transfer measurement. As shown in FIG. 9, the chamber was used to simulate the stable ambient environment, which has been demonstrated in the previous study. For the heat transfer coefficient (h) measurement, the difference between T₃ and T_{ambient} was controlled, and the heat flux of heater 2 (q) was recorded. h can then be expressed by

$$h = \frac{q}{{T}_{3} - {T}_{a m b i e n t}} ( W / {m}^{2} K )$$

For the real-time thermal measurements of device in changeable ambient temperatures, the heat flux of heater 2 was set to be constant, and the temperatures of T₃ and T_{ambient} were recorded.

The systems and methods described herein can be implemented in hardware, software, firmware, or combinations of hardware, software and/or firmware. In some examples, the systems and methods described in this specification may be implemented using a non-transitory computer readable medium storing computer executable instructions that when executed by one or more processors of a computer cause the computer to perform operations. Computer readable media suitable for implementing the systems and methods described in this specification include non-transitory computer-readable media, such as disk memory devices, chip memory devices, programmable logic devices, random access memory (RAM), read only memory (ROM), optical read/write memory, cache memory, magnetic read/write memory, flash memory, and application-specific integrated circuits. In addition, a computer readable medium that implements a system or method described in this specification may be located on a single device or computing platform or may be distributed across multiple devices or computing platforms.

One skilled in the art will readily appreciate that the present disclosure is well adapted to carry out the objects and obtain the ends and advantages mentioned, as well as those inherent therein. The present disclosure described herein are presently representative of preferred embodiments, are exemplary, and are not intended as limitations on the scope of the present disclosure. Changes therein and other uses will occur to those skilled in the art which are encompassed within the spirit of the present disclosure as defined by the scope of the claims.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

We claim:

1. An electrochromic device comprising:
an ultra-wideband transparent conducting electrode (UWB-TCE) comprising:
an IR-transparent conductor layer;
a metal microgrid on the IR-transparent conductor layer; and
an IR-transparent substrate on the IR-transparent conductor layer and the metal microgrid,
wherein the electrochromic device is switchable between a solar heating mode and a radiative cooling mode including coating a metal layer on the UWB-TCE for the heating mode and stripping the metal layer for the cooling mode.

2. The electrochromic device of claim 1 wherein the IR-transparent conductor layer comprises a graphene layer.

3. The electrochromic device of claim 2 wherein the graphene layer is a graphene monolayer.

4. The electrochromic device of claim 1 wherein the metal microgrid comprises a gold microgrid.

5. The electrochromic device of claim 1 wherein the IR-transparent substrate comprises PE film.

6. The electrochromic device of claim 1 wherein the UWB-TCE has a transmittance of at least 80% in the wavelength range of 0.2 μm to 20 μm.

7. The electrochromic device of claim 1 wherein the UWB-TCE has a thickness of 3 nm or less.

8. The electrochromic device of claim 1 wherein the UWB-TCE is flexible.

9. The electrochromic device of claim 1 wherein the UWB-TCE has a sheet resistance of 25 ohm/sq or less.

10. The electrochromic device of claim 1 wherein the UWB-TCE is a working electrode, the device further comprising a counter electrode and electrolyte between the working electrode and the counter electrode.

11. The electrochromic device of claim 10 wherein the electrolyte contains silver and/or copper ions.

12. A method of synergistic solar and radiative heat management, the method comprising:
providing an electrochromic device comprising an ultra-wideband transparent conducting electrode (UWB-TCE), the UWB-TCE comprising:
a graphene layer;
a gold microgrid on the graphene layer; and
an IR-transparent substrate on the graphene layer and the gold microgrid;
switching the electrochromic device between a solar heating mode and a radiative cooling mode a plurality of times.

13. The method of claim 12 wherein switching the electrochromic device between the solar heating mode and the radiative cooling mode comprises coating a metal layer on the UWB-TCE for the heating mode and stripping the metal layer for the cooling mode.

14. The method of claim 13 wherein the UWB-TCE is a working electrode, the electrochromic device further comprising a counter electrode and electrolyte between the working electrode and the counter electrode, and wherein:
coating the metal layer comprises applying a first voltage to the UWB-TCE to deposit metal thereon; and
stripping the metal layer comprises applying a second voltage to the UWB-TCE to oxidize the metal to ions and dissolve the ions into the electrolyte.

15. The method of claim 12 wherein the graphene layer is a graphene monolayer.

16. The method of claim 12 wherein the IR-transparent substrate comprises PE film.

17. The method of claim 12 wherein the UWB-TCE has a transmittance of at least 80% in the wavelength range of 0.2 μm to 20 μm.

18. An ultra-wideband transparent conducting electrode (UWB-TCE) for an electrochromic device, the UWB-TCE comprising:
a graphene layer;
a gold microgrid on the graphene layer; and
a PE film on the graphene layer and the gold microgrid.
